(19) United States
(12) Patent Application Publication
(10) Pub. No.: US 2006/0242611 A1
(43) Pub. Date: Oct. 26, 2006

(54) Integrating programmable logic into personal computer (PC) architecture

(75) Inventor: Stephen R. Drake, Seattle, WA (US)

Correspondence Address: WOODCOCK WASHBURN LLP (MICROSOFT CORPORATION), ONE LIBERTY PLACE - 46TH FLOOR, PHILADELPHIA, PA, 19103, US

(73) Assignee: Microsoft Corporation, Redmond, WA (US)

(21) Appl. No.: 11/101,138

(22) Filed: Apr. 7, 2005

(51) Int. Cl. G06F 17/50

(52) U.S. Cl. 716/1

(57) ABSTRACT

A portion of chip die real estate is allocated to blocks of programmable logic (PL) fabric. These blocks can be used to load special purpose processors which operate in concert with the general purpose processors (GPPs). These processors, implemented in PL, may integrate with a PC system architecture. Blocks of PL are integrated with fixed blocks of logic interfaces connecting, for example, to a system's front side bus. This facilitates configuration of the PL as coprocessors or other devices that may operate as peers to GPPs in the system. Moreover, blocks of PL may be integrated with fixed logic interfaces to existing IO buses within a system architecture. This facilitates configuration of the PL as soft devices, which may appear to the system as physical devices connected to the system. These soft devices can be handled like physical devices connected to the same or similar IO buses.

### FIELD OF THE INVENTION

The present invention relates generally to the field of computers, and, more particularly, to integrating programmable logic into computer architecture.

### BACKGROUND OF THE INVENTION

In the world of digital electronic systems, logic devices provide specific functions, including device-to-device interfacing, data communication, signal processing, data display, timing and control operations, etc. Programmable logic (PL) (as opposed to fixed logic) is generally available as off-the-shelf parts or devices that offer a wide range of features and characteristics. Programmable logic can be configured (or programmed) to perform any number of functions. Some types of programmable logic may only be configured once, while other types may be re-configured any number of times. Programmable logic comprises arrays of basic logic elements and programmable inter-connects. Each logic element may be programmed to perform a combinational logic function, and typically includes one or more flip flops to hold state. Two major types of programmable logic devices are field programmable gate arrays (FPGAs) and complex programmable logic devices (CPLDs). Thus, conventionally, programmable logic resides in stand-alone devices that are separate from the other components of a computer system.

A conventional personal computer (PC) architecture (e.g., the Windows(& PC architecture) relies on one or more complex general purpose processors (GPPs) (e.g., Pentium, PowerPC) to perform all control and data processing operations. By their nature, these GPPs are well suited for some tasks, but they are particularly poorly suited for other tasks. As a result of their general purpose design, these processors tend to have many more transistors, and require many more transistor state switches to perform the same task as a special purpose processor designed specifically for a particular class of operations. As a result, there are certain common operations performed by the GPPs of a typical PC that perform more slowly and consume more electrical energy than would be expected from a custom processor designed specifically for a given operation (e.g., media encoding/decoding, cryptographic algorithms, digital signal processing, and low level IO processing).

A conventional high level hardware implementation for computers is shown in FIG. 1. A main processor die 100 comprises one or more GPPs 102. The main processor die 100 does not contain any programmable logic.

The GPPs 102 are connected by a front side bus (FSB) to other sub-systems, such as the Northbridge 140 (or Memory Controller Hub, MCH). Northbridge 140 is connected to the Southbridge 170 (or IO Controller Hub, ICH). Northbridge 140 and Southbridge 170 are an example chipset pair by Intel. Northbridge communicates with the computer processor and controls interaction with memory and the Accelerated Graphics Port (AGP). Northbridge communicates with the processor using the FSB. Southbridge manages the basic forms of input/output (IO) such as the Peripheral Component Interconnect (PCI) bus, Universal Serial Bus (USB), serial, audio, Integrated Drive Electronics (IDE), and Industry Standard Architecture (ISA) IO in a computer.

While reductions in micro-chip fabrication process geometries have allowed ever more transistors to be packed into a given area of a chip die, a system designer's ability to utilize this new capacity has been limited by the physical number of pads, or pins, that can be added to a micro-chip package to communicate with external circuitry—their functionality is said to be “pad limited”. The prevailing trend in the usage of this pad limited chip die real estate, by processor manufacturers, is to increase the size of processor cache memory, and to add multiple identical GPP cores, with the goal of increasing the overall processing throughput of the system.

However, GPPs are inherently inefficient for certain operations. In view of the foregoing, there is a need for systems and methods that overcome such deficiencies.

### SUMMARY OF THE INVENTION

The following summary provides an overview of various aspects of the invention. It is not intended to provide an exhaustive description of all of the important aspects of the invention, nor to define the scope of the invention. Rather, this summary is intended to serve as an introduction to the detailed description and figures that follow.

The present invention is directed to allocating some of the chip die real estate in a computer architecture, currently being allocated to larger processor caches and multiple processor cores, to blocks of programmable logic fabric. This extends the capability of the processor core.

According to further aspects of the invention, the programmable logic is presented to the operating system using a device driver model. The programmable logic appears to be one or more devices represented by a device driver using existing device driver mechanics of the host operating system.

Additional features and advantages of the invention will be made apparent from the following detailed description of illustrative embodiments that proceeds with reference to the accompanying drawings.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary constructions of the invention; however, the invention is not limited to the specific methods and instrumentalities disclosed. In the drawings:

FIG. 1 is a high level block diagram of a conventional hardware implementation for computers;

FIG. 2 is a block diagram of an exemplary system in accordance with the present invention;

FIG. 3 is a block diagram of an exemplary programmable logic (PL) software integration in accordance with the present invention;

FIG. 4 is a flow diagram of an exemplary PL software integration method in accordance with the present invention; and

FIG. 5 is a block diagram showing an example computing environment in which aspects of the invention may be implemented.

### DETAILED DESCRIPTION OF ILLUSTRATIVE EMBODIMENTS

The subject matter is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the term “step” may be used herein to connote different elements of methods employed, the term should not be interpreted as implying any particular order among or between various steps herein disclosed unless and except when the order of individual steps is explicitly described.

It is noted that, while the description of example embodiments of invention herein may refer to a specific computer architecture (e.g., a Windows® PC system architecture), the invention is not limited thereto and applies to any computer system based on general purpose processors implemented in VLSI, with an operating system (OS) supporting an extensible device driver model. For example, the techniques of the present invention could be applied to optimize Linux running on a PC platform, or an Apple Macintosh system.

The present invention addresses the inherent inefficiencies of general purpose processors (GPPs) for certain operations. According to aspects of the invention, some of the chip die real estate, currently being allocated to larger processor caches and multiple processor cores, is instead allocated to blocks of programmable logic (PL) fabric. These blocks of programmable logic can be used to dynamically load special purpose processors, which operate in concert with the GPPs, to assist in tasks that the GPPs are not well suited to perform. These dynamic custom processors, implemented in programmable logic, may integrate with the hardware and software system architecture of a PC.

As described further herein, blocks of programmable logic are integrated with fixed blocks of logic interfaces connecting, for example, to a system's front side bus. This arrangement facilitates configuration of the programmable logic as coprocessors or other devices that may operate as peers to any general purpose processors in the system.

Moreover, blocks of programmable logic may be integrated with fixed logic interfaces to existing standard IO buses within a system architecture. This arrangement facilitates configuration of the programmable logic as virtual devices, which may appear to the system as physical devices connected to the system. This allows the operating system to handle these virtual devices exactly as it handles physical devices connected to the same or similar IO buses.

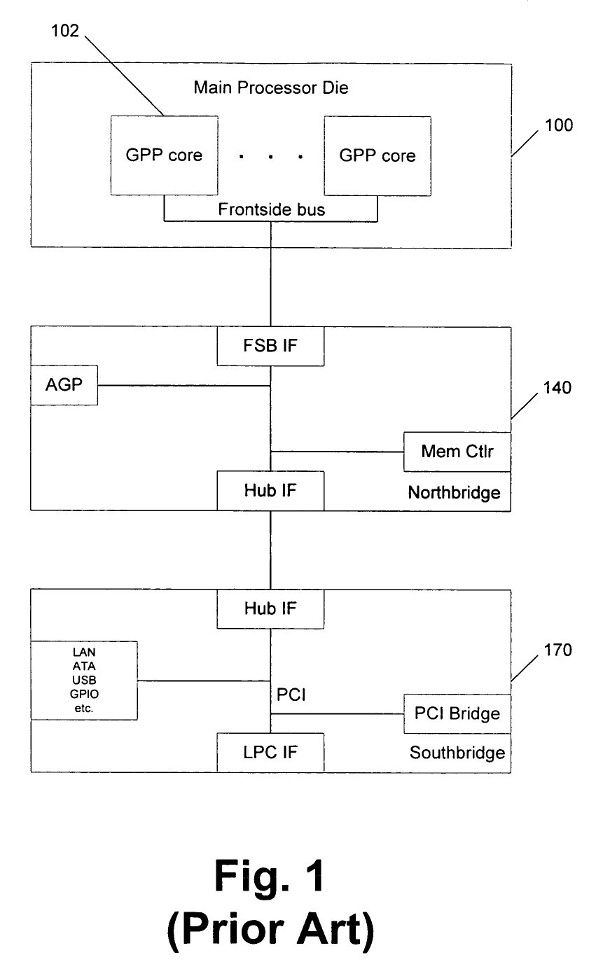

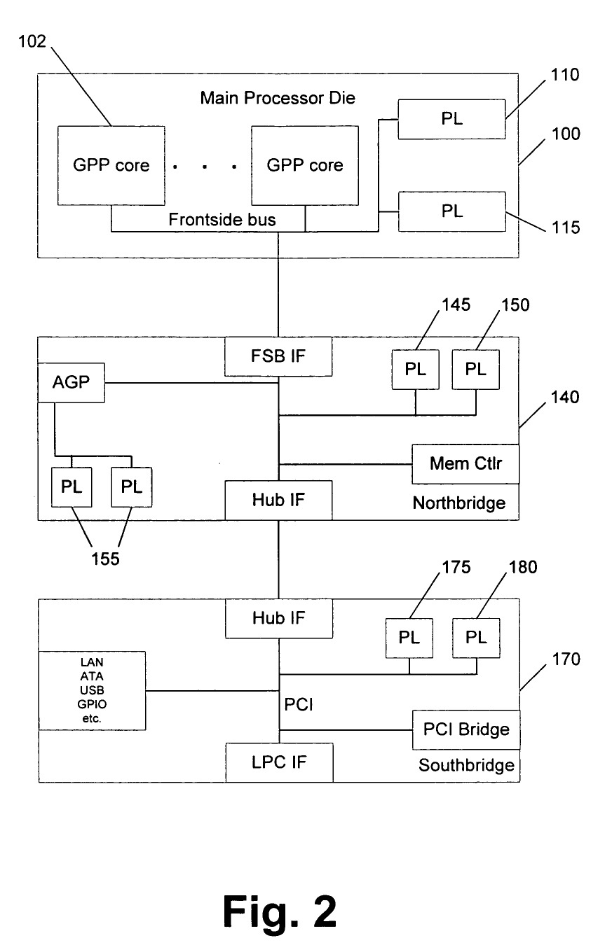

FIG. 2 is a block diagram of an exemplary system in accordance with the present invention. As in FIG. 1, one or more GPPs 102 reside on the main processor die 100. These GPPs are connected to the front side bus, and then out of the die 100 (e.g., to the Northbridge 140). The GPPs are conventional GPPs, and may comprise a core and cache, for example, as well as front side bus (FSB) interfaces, etc. Programmable logic is also disposed on the main processor die 100. The PL is shown as elements 110, 115, though it is contemplated than any number of PL elements may reside on the die 100. Each PL 110, 115 may be dynamically configured to act as a special purpose processor, such as coprocessors or IO processors, or to perform any other function within the capabilities of the underlying programmable logic. Each block of PL may also be provisioned with supporting fixed logic to, for example, interface it to the FSB, allow it to generate and handle interrupts from other devices or processors, and provide a test access port (TAP) for developing and testing PL configurations.

Moreover, PL may be implemented in other chipsets in the computer architecture, such as in the Northbridge 140 and/or Southbridge 170. Because the FSB extends into Northbridge 140, it is also possible to host coprocessors and IO processors there. For example, PL 145, 150 may be disposed on the Northbridge 140 as a coprocessor or IO processor, for example, or any other function within the capabilities of the PL. Additionally, PL 155 may be disposed as soft devices on the PCI bus segment typically implemented within the Northbridge 140. Similarly, PL 175, 180 may be disposed as soft devices, for example, on the Southbridge 170.

It is contemplated than any number of PL elements may reside on the Northbridge 140 and/or Southbridge 170. Each such PL may be provisioned with fixed logic to include, for example, a test access port, appropriate interfaces, etc.

Thus, within an example hardware architecture, PL could be disposed on-die with GPP core(s). This provides a high speed clock domain with access to FSB interface, bus arbitration logic, and logic to generate and handle system interrupts, for example. Programmable logic could also be disposed on-die with Northbridge. This provides a high speed clock domain and access to FSB, and is also capable of hosting a medium speed IO bus (e.g., AGP and associated secondary PCI bus). Moreover, PL may be disposed on-die with Southbridge. This provides a medium speed clock domain, limited, indirect access to FSB, and is internally PCI based.

Some models for exposing PL within an exemplary computer system architecture include a coprocessor, an IO processor, and a soft device. Such functionality may be implemented through PL.

A coprocessor may be used for parallel execution of application specific algorithms, e.g., media encode/decode, cryptographic algorithms, etc. A coprocessor implemented through PL on a die desirably has full access to physical memory and IO space, can handle interrupts from IO devices or other processors, and can generate interrupts handled by other processors.

An IO processor implemented through PL on a die may replace lower layers of performance critical device drivers (e.g., operations typically performed in interrupt service routines and deferred procedure calls—in the vernacular of the Windows operating system). For example, such PL could provide basic queuing/dequeuing, scatter/gather algorithms, or data translations, without disrupting GPP cores. A PL-implemented IO processor desirably has access to physical memory and IO space, can handle interrupts from managed devices, and generate interrupts to GPPs on behalf of managed devices.

Thus, desired characteristics and features of coprocessors and IO processors can be met by placing blocks of PL on-die with the GPP core(s), and providing them with fixed FSB interface logic and local interrupt controller logic.

A soft device implemented through PL may emulate a physical device connected through a standard or custom IO bus (e.g., PCI). Moreover, an exemplary soft device may provide stand-alone functionality with no physical interface, or work in conjunction with a physical device. In this latter case, for example, the functionality of a device could be divided between a physical device interface board providing analog functions and real-world interfaces, while digital control and processing logic would be implemented in PL. Desirably, a soft device implemented in PL would be indistinguishable from physical devices to the operating system. Furthermore, such a soft device desirably supports DMA transfers to/from system memory, and can generate interrupts.

Desired characteristics and features of soft devices can be met by placing blocks of PL on existing buses within Northbridge and/or Southbridge. For example, a PCI bridge may be provided from the primary PCI bus within Southbridge, and blocks of PL are connected to this bus through fixed PCI interface logic for each available soft device “slot”.

Example approaches to integrating PL logic include discrete PL blocks, each with a dedicated system interface logic block; discrete PL blocks with multiple dedicated system interface logic blocks; and a managed pool of PL fabric with synthesized system interface logic. By making multiple, fixed logic, system interface blocks available to each PL block, the operating system can control allocation of the fabric of a PL block to a few complex functions, or many simple functions, or any desired combination that fits within the available PL fabric and available system interface blocks. A unified, managed pool of PL fabric allows finer grain allocation of PL resources, but puts additional burden on the designer to synthesize system integration and arbitration logic in PL.

Thus, programmable logic is implemented on some of the free chip die real estate of the processor chips or other chips within a system's chipset, thereby extending the capability of the system. Once loaded with a particular logic configuration, such PL appears as devices on the system. In other words, from the point of view of the operating system, configured PL appears to be additional physical devices or processors on the system. Prior to configuration, the PL appears to the operating system as an additional hardware resource to manage and to allocate to applications. Programmable logic does not require external pins or pads, and communicates through the internal buses already disposed on the chip die.

Conventionally, the PL (implemented in separate or stand-alone devices) is not presented at all to the OS. In accordance with aspects of the present invention, the PL gets presented to the OS as one or more devices represented by a device driver, using existing device driver mechanics of the host OS. Prior to loading a specific logic configuration into a block of programmable logic, the PL stands as a generic resource on a bus. On startup, the PL just appears to be blocks of PL. At some point, the OS allocates the blocks of PL to certain applications. An application specific logic configuration is then loaded in to the PL, and the newly configured PL appears as a new device, of a type determined by its configuration, on the bus to which it is connected. Conversely, at some point, the OS may choose to unload the configuration of a block of PL, reverting it back to a generic block of PL. This cycle of allocation, configuration, usage, and decommissioning may be dynamically repeated as often as desired while the system is running.

Support for PL development may include providing standard JTAG (IEEE 1149.1) boundary scan cells within each block of PL. Fixed boundary scan cells may be allocated on each system interface signal, along with a pool of additional boundary scan cells within the PL fabric for general use in logic designs. Moreover, standard test access port (TAP) components may be provided as a resource with each block of PL. The TAP can be chained with system TAPs for external access for cross development, or exposed through system memory or IO space to allow direct TAP access to target hosted development tools, for example.

Because PL is a limited hardware resource, in accordance with the present invention, it is managed and allocated by the OS, just like any other hardware resource. PL resources are desirably enumerated by a root bus device driver and represented by an instance of a device driver. For example, there may be a different type of device driver for each distinct class of PL resource (e.g., defined by the structure of the PL and how/where it is integrated into the system).

The device driver associated with a block of PL may be used by the OS to manage that resource (e.g., to query its capabilities, control its power plane, load a logic configuration, configure and access its test access port, etc.)

When a logic configuration is loaded to a PL block and activated, it will be enumerated by its associated bus as a new device, and the operating system will load an appropriate device driver to represent the type of device defined by this configuration. This second driver stack represents the function provided by the loaded logic configuration.

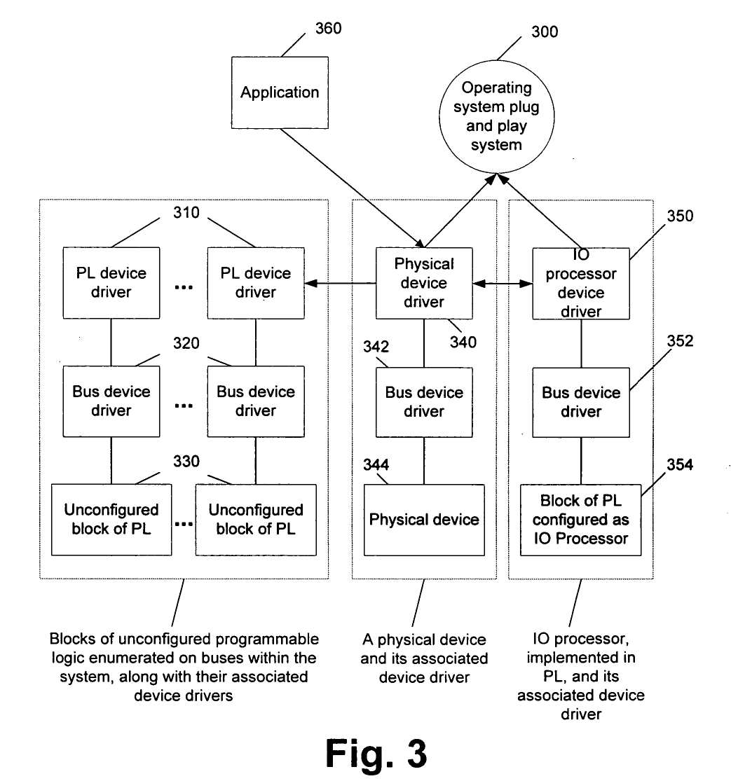

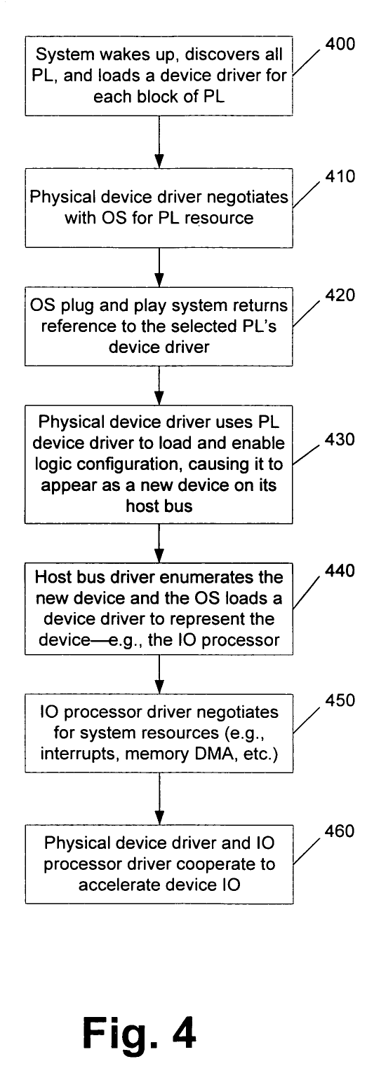

FIG. 3 is a block diagram of an exemplary PL software integration in accordance with the present invention, and FIG. 4 is a corresponding flow diagram. This example is directed to an IO processor and is presented in terms of the Microsoft Windows Driver Model, though other devices or functionality may be implemented in a similar way, using similar techniques, and using mechanisms available in any modern operating system.

At step 400, the system wakes up, and enumerates all devices attached to all buses within the system. During this process, blocks of programmable logic 330 are discovered and enumerated as generic PL “devices” attached to their associated host bus by the host bus drivers 320—for example, on the front side bus of the processor die or on a PCI bus segment within the Southbridge. Consistent with the handling of any device discovered during this enumeration process, the operating system loads a device driver to represent each PL “device” 310. It is noted that this device driver represents the generic block of programmable logic itself, and it is used to access and manage the PL-for example, allowing the system to later load logic configurations into the PL. This is distinct from a device driver representing the functionality created by loading and enabling a new logic configuration within the PL.

In the example of an IO processor, it is generally the case that the IO processor will accelerate access to a physical device 344 which is attached to an associated bus device driver 342. The physical device 344 may be called or otherwise accessed by an application 360. When the device driver of the physical device 340 is loaded by the OS, it will negotiate with the operating system for a PL resource, at step 410. The OS's plug and play system 300 chooses an appropriate PL resource—as discovered in step 400—and returns a reference to the chosen PL's device driver 310, at step 420. The physical device driver 340 then uses the PL device driver 310 to load and enable its required logic configuration into the programmable logic block, at step 430. At this point, the PL appears as a new device on its host bus 354. The device is of a type determined by the newly loaded logic configuration.

When the logic configuration is loaded and enabled in the PL block 354, at step 440, its associated bus driver 352 enumerates the new device (e.g., IO processor device), and loads a device driver that represents the new device 350. To emphasize, this device driver 350 represents the device and device functionality created by the logic configuration now loaded into the block of PL. This is distinct from the previously loaded device driver 310 that represents the generic block of PL.

The IO processor driver 350 negotiates with the OS 300 for any desired system resources (e.g., interrupts, memory DMA, etc.), at step 450. The physical device driver 340 and the IO processor driver 350 then cooperate to accelerate device IO, at step 460. For example, while the IO processor device driver 350 and associated logic configuration in PL 354 may handle low level interrupts, data buffering and data transformation, for a disk drive device, the physical device driver 340 may handle higher level functions like managing the layout of files and directories on the device.

Thus, a plug and play resource negotiation mechanism may be extended to allow drivers to request PL resources. Application related drivers negotiate for PL resources, load a logic configuration, and enable the configuration. The bus driver of an enabled PL function enumerates the new device and builds a driver stack. The PL function is now available through this new driver stack.

For an IO processor, the physical device driver is the device driver associated with the physical device being managed. Once the driver stack for this driver is loaded, it negotiates for PL resources in which the associated IO processor will be created. The driver calls the device driver of the assigned PL to load the IO processor logic configuration and starts this processor. When the IO processor is started, its host bus enumerates it, and loads its associated device driver. At this point, the managed device's device driver and the IO processor's device driver work together to provide accelerated access to the managed device.

Soft devices are initialized similar to IO processors. In this case, a root enumerated driver is associated with the soft device. The system loads this “bootstrap” driver which negotiates for the PL resource, loads the logic configuration and enables it. At that point, the plug and play system takes care of loading the real soft device driver, and the soft device is available for use.

For coprocessors, it is desirable that the current set of loaded coprocessors dynamically track actual application usage of these coprocessors. OS extensions may be considered to support coprocessor PL. The operating system would use an extension to track installed and active coprocessors, and to associate applications with coprocessors. Applications may be either tagged with coprocessor requirements at build-time, or they request coprocessor support, through a new API, at run-time. The OS desirably provides a mechanism for installing and cataloging available coprocessors. When a coprocessor is requested by an application, the OS may allocate available PL resources based on application priority. When the OS grants an application's request for a coprocessor, it first loads the logic configuration of the coprocessor into the assigned PL block, the plug and play system detects the newly created coprocessor device, and loads its device driver, and the OS opens a handle to the device through this driver. The handle is returned to the application, and is used to access the coprocessor.

Thus, blocks of programmable logic are desirably resources managed by the operating system. These resources are desirably discovered using the same method used by the operating system to discover any other hardware resource. For example, a Microsoft Windows® plug and play system and bus driver architecture would detect available blocks of programmable logic, and represent each block by an instance of a device driver, e.g., as set forth above with respect to FIGS. 3 and 4.

When a logic configuration is loaded into a block of programmable logic and enabled, the block is detected and recognized as a new device of a type defined by the current logic configuration. The OS desirably represents this new device with an appropriate device driver. For example, Windows® plug and play system and bus driver architecture detects the presence of a newly loaded and enabled logic configuration, and loads a device driver to represent the function of this current logic configuration.

Some PL functions will need system resources like interrupts, physical memory or IO address blocks, DMA channels, etc. For example, a coprocessor might use a fixed block of memory for passing arguments and return values, and an interrupt to signal completion.

A device driver (the device driver of the PL-implemented function) is desirably loaded upon enabling the PL function, and uses normal plug and play resource negotiation to acquire the desired resources.

A programmable logic configuration—a block of binary data that controls the internal operation of the PL, and determines the current functional behavior of the PL—is typically authored in a hardware description language, which is independent of the target PL, and then compiled to a binary form specific to the target PL. It is contemplated that this compilation process may occur at one of several possible steps in the process of creating and distributing logic configurations. For example, dynamic compilation may be performed at logic configuration load-time. Alternately, install-time compilation may be performed once at the time that the associated component is installed. Uniform compilation may be used if PL within a PC architecture has a uniform and well defined structure, so compilation can be done once prior to distribution. This models the current software compile/link model, where the target execution environment is completely known at build-time.

It is contemplated that an interrupt controller may be implemented in fixed logic, with each block of programmable logic interfacing to the system's front side bus. This allows configuration of programmable logic as coprocessors that are capable of handling system interrupts—either from other processors or from IO devices.

Additionally, with each block of programmable logic, JTAG boundary scan cells may be included along with a test access port (TAP). These may be implemented in fixed logic, and accessible both from the system's IO and/or memory space, and from external pins, facilitating in-system development of programmable logic configurations both with system hosted tools and external tools.

Multiple fixed logic system interfaces may be provided per block of programmable logic fabric. This allows the operating system to choose, based on current application demand, to allocate the fabric to a few complex functions, or many less complex functions, or any desired combination that fits within the available PL fabric and available system interface blocks.

Moreover, the implementation of a hardware peripheral may be divided between a physical IO board, providing physical interface connections and analog electronics, and digital control and data processing functions implemented in system provided programmable logic.

Thus, programmable logic is folded into a computer system architecture by extending existing mechanisms, both in the system hardware and software. Programmable logic may then be used to implement separate, parallel, special purpose coprocessors or other devices, for example.

Example Computing Environment

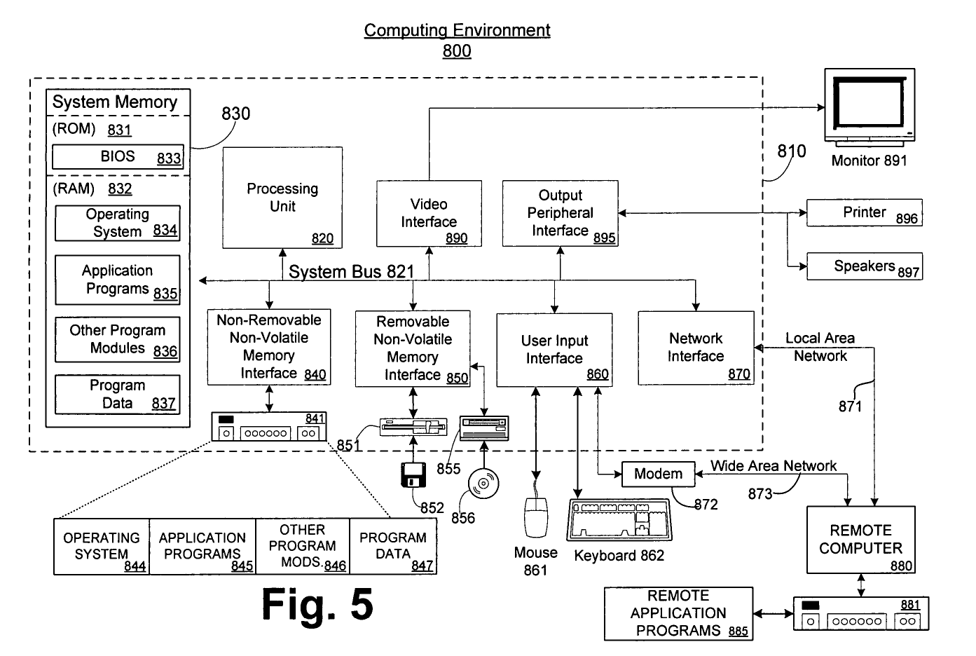

FIG. 5 and the following discussion are intended to provide a brief general description of a suitable computing environment in which an example embodiment of the invention may be implemented. It should be understood, however, that handheld, portable, and other computing devices of all kinds are contemplated for use in connection with the present invention. While a general purpose computer is described below, this is but one example. The present invention also may be operable on a thin client having network server interoperability and interaction. Thus, an example embodiment of the invention may be implemented in an environment of networked hosted services in which very little or minimal client resources are implicated, e.g., a networked environment in which the client device serves merely as a browser or interface to the World Wide Web.

Although not required, the invention can be implemented via an application programming interface (API), for use by a developer or tester, and/or included within the network browsing software which will be described in the general context of computer-executable instructions, such as program modules, being executed by one or more computers (e.g., client workstations, servers, or other devices). Generally, program modules include routines, programs, objects, components, data structures and the like that perform particular tasks or implement particular abstract data types. Typically, the functionality of the program modules may be combined or distributed as desired in various embodiments. Moreover, those skilled in the art will appreciate that the invention may be practiced with other computer system configurations. Other well known computing systems, environments, and/or configurations that may be suitable for use with the invention include, but are not limited to, personal computers (PCs), automated teller machines, server computers, hand-held or laptop devices, multi-processor systems, microprocessor-based systems, programmable consumer electronics, network PCs, minicomputers, mainframe computers, and the like. An embodiment of the invention may also be practiced in distributed computing environments where tasks are performed by remote processing devices that are linked through a communications network or other data transmission medium. In a distributed computing environment, program modules may be located in both local and remote computer storage media including memory storage devices.

FIG. 5 thus illustrates an example of a suitable computing system environment 800 in which the invention may be implemented, although as made clear above, the computing system environment 800 is only one example of a suitable computing environment and is not intended to suggest any limitation as to the scope of use or functionality of the invention. Neither should the computing environment 800 be interpreted as having any dependency or requirement relating to any one or combination of components illustrated in the exemplary operating environment 800.

With reference to FIG. 5, an example system for implementing the invention includes a general purpose computing device in the form of a computer 810. Components of computer 810 may include, but are not limited to, a processing unit 820, a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

Computer 810 typically includes a variety of computer readable media. Computer readable media can be any available media that can be accessed by computer 810 and includes both volatile and nonvolatile, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, random access memory (RAM), read-only memory (ROM), Electrically-Erasable Programmable Read-Only Memory (EEPROM), flash memory or other memory technology, compact disc read-only memory (CDROM), digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above should also be included within the scope of computer readable media.

The system memory 830 includes computer storage media in the form of volatile and/or nonvolatile memory such as ROM 831 and RAM 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 5 illustrates operating system 834, application programs 835, other program modules 836, and program data 837. RAM 832 may contain other data and/or program modules.

The computer 810 may also include other removable/non-removable, volatile/nonvolatile computer storage media. By way of example only, FIG. 5 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856, such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 5 provide storage of computer readable instructions, data structures, program modules and other data for the computer 810. In FIG. 5, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. A user may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus 821, but may be connected by other interface and bus structures, such as a parallel port, game port or a universal serial bus (USB).

A monitor 891 or other type of display device is also connected to the system bus 821 via an interface, such as a video interface 890. In addition to monitor 891, computers may also include other peripheral output devices such as speakers 897 and printer 896, which may be connected through an output peripheral interface 895.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 5. The logical connections depicted in FIG. 5 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 5 illustrates remote application programs 885 as residing on memory device 881. It will be appreciated that the network connections shown are exemplary and other means of establishing a communications link between the computers may be used.

One of ordinary skill in the art can appreciate that a computer 810 or other client devices can be deployed as part of a computer network. In this regard, the present invention pertains to any computer system having any number of memory or storage units, and any number of applications and processes occurring across any number of storage units or volumes. An embodiment of the present invention may apply to an environment with server computers and client computers deployed in a network environment, having remote or local storage. The present invention may also apply to a stand-alone computing device, having programming language functionality, interpretation and execution capabilities.

The various systems, methods, and techniques described herein may be implemented with hardware or software or, where appropriate, with a combination of both. Thus, the methods and apparatus of the present invention, or certain aspects or portions thereof, may take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for practicing the invention. In the case of program code execution on programmable computers, the computer will generally include a processor, a storage medium readable by the processor (including volatile and non-volatile memory and/or storage elements), at least one input device, and at least one output device. One or more programs are preferably implemented in a high level procedural or object oriented programming language to communicate with a computer system. However, the program(s) can be implemented in assembly or machine language, if desired. In any case, the language may be a compiled or interpreted language, and combined with hardware implementations.

The methods and apparatus of the present invention may also be embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, a video recorder or the like, the machine becomes an apparatus for practicing the invention. When implemented on a general-purpose processor, the program code combines with the processor to provide a unique apparatus that operates to perform the functionality of the present invention.

While the present invention has been described in connection with the preferred embodiments of the various figures, it is to be understood that other similar embodiments may be used or modifications and additions may be made to the described embodiments for performing the same functions of the present invention without deviating therefrom. Therefore, the present invention should not be limited to any single embodiment, but rather construed in breadth and scope in accordance with the appended claims.

What is claimed:

1. A computer system comprising:
a chip die; and
programmable logic disposed on the chip die.

2. The computer system of claim 1, wherein the chip die comprises a general purpose processor.

3. The computer system of claim 1, wherein the chip die comprises a memory controller hub or an input/output (IO) controller hub.

4. The computer system of claim 1, wherein the chip die is a processor chip die or a die of supporting chips within the computer system.

5. The computer system of claim 1, wherein the programmable logic is exposed as at least one of a coprocessor, an input/output processor, and a soft device.

6. The computer system of claim 1, wherein the programmable logic may be configured to perform any function within the intrinsic capabilities of the programmable logic itself and of a system bus through which it is connected.

7. The computer system of claim 1, wherein the programmable logic may be configured to operate as a special purpose processor or any other digital logic device, within the intrinsic capabilities of the programmable logic.

8. A method of presenting programmable logic to an operating system, the programmable logic residing on a chip die, comprising:
detecting the programmable logic; and
representing the programmable logic by a device driver.

9. The method of claim 8, further comprising loading a logic configuration into the programmable logic and enabling the logic configuration.

10. The method of claim 9, wherein the logic configuration has a function, and further comprising loading the device driver to represent the function of the logic configuration.

11. The method of claim 8, wherein the programmable logic represents at least one of a coprocessor, an input/output processor, and a soft device.

12. The method of claim 8, wherein the programmable logic may be configured to perform any function within the intrinsic capabilities of the programmable logic itself and of a system bus through which it is connected.

13. The method of claim 8, wherein the programmable logic may be configured to operate as a special purpose processor or any other digital logic device, within the intrinsic capabilities of the programmable logic.

14. A method of exposing programmable logic in a computer system, comprising:
disposing programmable logic on a chip die; and
presenting the programmable logic to an operating system.

15. The method of claim 14, wherein the programmable logic is electrically attached to an internal bus through a fixed logic interface, on the chip die.

16. The method of claim 14, wherein the programmable logic may be dynamically re-configured while the computer system is operational.

17. The method of claim 14, wherein presenting the programmable logic to the operating system comprises:
detecting the programmable logic; and
representing the programmable logic by a device driver.

18. The method of claim 17, further comprising loading a logic configuration into the programmable logic and enabling the logic configuration.

19. The method of claim 18, wherein the logic configuration has a function, and further comprising loading the device driver to represent the function of the logic configuration.

20. The method of claim 14, wherein the programmable logic may be provisioned with additional fixed logic components to increase its utility within the system, including at least one of an interrupt controller, a test access port, and boundary scan cells.
